(19) United States
(12) Patent Application Publication
(10) Pub. No.: US 2025/0045214 A1
(43) Pub. Date: Feb. 6, 2025

(54) Platform for execution of avionic applications, and associated method and computer program

(71) Applicant: THALES, Meudon (FR)

(72) Inventor: Olivier BOULAUD, MERIGNAC (FR)

(21) Appl. No.: 18/786,522

(22) Filed: Jul. 28, 2024

(30) Foreign Application Priority Data
Aug. 3, 2023 (FR) 2308428

(51) Int. Cl. G06F 13/16

(52) U.S. Cl. CPC G06F 13/1663

(57) ABSTRACT

A platform for executing avionics applications including a shared memory space, a plurality of avionics partitions and an IOTC server for access to shared resources. The shared memory space is configured to perform any data sharing between a producer partition and a predetermined group of N data consuming partitions exclusively via a data sharing structure allocated in the shared memory space. The data sharing structure includes at least two saving addresses which may be used by the data producing partition for writing two different data.

### CROSS-REFERENCE TO RELATED APPLICATION

This application is a U.S. non-provisional application claiming the benefit of French Application No. 23 08428, filed on Aug. 3, 2023, which is incorporated herein by reference in its entirety.

### TECHNICAL FIELD OF THE INVENTION

The invention relates to the field of computer science. The invention relates more particularly to the field of real-time computing and more particularly still to the execution of computer programs within a real-time computerized avionics device which executes independent processes in parallel.

### BACKGROUND OF THE INVENTION

In many real-time devices, applications are executed deterministically. Such determinism takes the form of a temporal determinism: for the execution thereof, application is allocated an execution time range and the execution should be carried out within the allocated time range. The determinism also takes the form of a result determinism: during the execution thereof in the allotted time period, the application should often produce an execution result. The execution of different applications by the real-time device is scheduled. The scheduling is performed by a scheduler operating within the real-time device. The purpose of scheduling is to distribute resources and time between all applications.

The situation is complicated when the real-time device has to manage the execution, in parallel, of a plurality of applications. This is the case, e.g., in the field of avionics. In this field, an execution device may, e.g., be used to execute in parallel applications that may perform the same functions, whether similar or not. The applications may be identical (the same code is executed twice) or different (there are two different codes). The functions, whether different, identical or similar, may need to use resources. For example, input/output resources (I/O resources) or messages. However, e.g., in the field of on-board avionics, the increase in the number of functions to be performed by electronic devices is constantly increasing. On the other hand, key characteristics of the electronic devices are reduced to the maximum for economic and ecological reasons. It is thereby necessary to have more computing power while reducing consumption and SWaP (Size, Weight and Power).

Electronic devices on which such parallel real-time processing is performed typically consist of one or a plurality of processors and shared memory. Thereof is, e.g., multi-core processors. Indeed, the increase in computing power now necessarily requires the use of System-on-Chips (SoCs) which integrate, among other things, a plurality of cores used for the execution of software in parallel, through the sharing of resources, and more particularly, access to remote I/O devices.

Thereby, a suitable real-time operating system runs on such electronic devices and the operating system schedules the execution of applications, using the scheduler, in partitions. A partition is defined as the allocation of specified execution time and resources (CPU, memory). Thereby, for the execution thereof, each application has a partition allocated to an execution channel (e.g., a processor or a processor core). The temporal and spatial isolation of the partition is the guarantee of the safety of the device. Within such framework, a given module comprises, e.g., two distinct execution channels, each channel executing a partition for a given time.

The use of multi-core architectures in the avionics field then involves the definition of a software architecture which preserves the essential properties for an IMA platform (incremental certification) which are: extended robust partitioning (ERP) and incrementality. Said two fundamental properties require:
that an application (or a group of controlled applications) has no influence on the other applications as long as the application or applications stay within the budget (time, memory, etc.) that is allocated; and
that the times of the services provided remain controlled regardless of the conditions of execution while remaining compatible with a maximum drift goal of partition switching not to exceed: thereof means that to switch from one application to another, a maximum time should not be exceeded.

However, a problem arises in particular for access to I/O resources. Indeed, some hardware devices dedicated to I/O do not support any concurrent access. For example, if two partitions are executed in parallel (e.g., by different cores of a processor), some peripherals do not allow both partitions to access the same hardware peripheral at the same time in order to obtain the value(s) same provide.

To provide a solution to such access problem, an I/O server was developed (an IOTC server). Such server, implemented by a specific partition, centralizes the access to the resources. The server is thus placed as an intermediary between the resources (notably I/O) and the partitions that wish to access them (either in read or write mode). Thereby, the resources are exclusively accessed by the IOTC server and the IOTC server makes the resulting data available to the partitions that wish to access same. Instead, it is the software data in question that become shared. The consequence is that the access, in read mode or in write mode, to a datum can be in competition between one (or a plurality of) consuming partitions (s) and the IOTC.

Such a case is illustrated by FIG. 7 in which the reference 111 identifies an IOTC server and the references “115” and “116” identify two partitions wishing to access the data made available by the IOTC server. The IOTC server thereby implements a shared memory accessible by each of the partitions 115 and 116.

The problem is to ensure, in a multi-core context, that at a given moment, a resource consuming partition (whether IOTC or an avionics partition) may, whatever happens, access the latest available value for said resource. The problem is also to ensure that at a given time, a producer partition (whether it is the IOTC server or an application) may, whatever happens, save a value (message, or value intended for another module).

In order to solve such problem, it would have been possible to require partitions to provide, in the execution time budgets thereof, a sufficient margin to absorb possible contentions (interferences) at the initiative of other competing partitions. However, such solution limits the overall time available for the execution of partitions and therefor is neither desirable nor efficient given the requirements listed hereinabove.

### SUMMARY OF THE INVENTION

The invention aims to solve such problems of the prior art. More particularly, the invention aims to enable all the data producing partitions and the data consuming partitions to have access to a datum without any need to increase the overall execution time or to provide access blocking mechanisms.

To this end, the invention relates to a platform for execution of avionics applications.

The platform comprises a multi-core processor, a memory, a management unit, and a plurality of shared resources.

The memory comprises a shared memory space the access of which is controlled by the management unit; a plurality of avionics partitions executing a plurality of avionics applications by the multi-core processor; and an IOTC server for accessing resources shared by the avionics partitions.

The shared memory space is configured to perform any data sharing between a producing partition and a predetermined group of N data consuming partitions exclusively via a data sharing structure allocated in said space, the or each data producing/consuming partition corresponding to the IOTC server or to one of the avionics partitions.

The data sharing structure comprises at least two saving addresses which can be used by the data producing partition for writing two different data.

According to other advantageous aspects of the invention, the platform comprises one or a plurality of the following features, taken individually or according to all technically possible combinations:
the shared memory space comprises a first shared memory zone and for each avionics partition, a second shared memory zone;
the first shared memory zone being read-only accessible to all avionics partitions and each second shared memory zone being accessible in read/write mode to the corresponding avionics partition;
the management unit being configured to make the different avionics partitions follow the reading/writing in said different zones. advantageously, each data sharing structure is distributed between said zones according to the need thereof to write/read corresponding data;
the data sharing structure further comprises at least one metadatum for determining a data saving address to be used by the or each data producer/consumer partition;
the data sharing structure has a structure of the first type when N is strictly greater than 1, the data producing partition corresponding to the IOTC server and each data consuming partition corresponding to one of the avionics partitions;
the structure of the first type comprising N+2 saving addresses;
among the N+2 saving addresses of the structure of the first type: two addresses are dedicated to the writing by the data producing partition of a preceding datum and a following datum; and N other addresses are dedicated to the reading by each of the N data consuming partitions of said predetermined group of the preceding datum;
the data sharing structure has a structure of the second type when N is equal to 1, the data producing partition corresponding to the IOTC server and the data consuming partition corresponding to a single avionics partition;
said at least two saving addresses forming a queue for reading/writing a preceding datum and a following datum;
the data sharing structure has a structure of the third type when N is equal to 1, the producer partition corresponding to a single avionics partition and the consumer partition corresponding to the IOTC server;
said at least two saving addresses forming a queue for reading/writing a preceding datum and a following datum;
the shared memory space comprises a structure of the second type and/or a structure of the third type for each avionics partition;
the shared memory space comprises a structure of the first type for each group of N avionics partitions sharing the data produced by the IOTC server; and
the shared memory space comprises a plurality of data sharing structures, each data sharing structure corresponding to a structure of the first type, a structure of the second type or a structure of the third type.

The invention also relates to a method for the execution of avionics applications, implemented by the platform as mentioned above, comprising the step of writing two different data into two saving addresses of said data sharing structure, by the data producing partition.

The invention further relates to a computer program including software instructions which, when executed by a programmable electronic device, implement a method as described hereinabove.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic view of a platform for the execution of avionics applications according to the invention;

FIG. 2 is a schematic view of a software architecture used by the platform shown in FIG. 1;

FIGS. 3-5 are schematic views illustrating the functioning of different data structures implemented by the platform shown in FIG. 1;

FIG. 6 is a schematic of a shared memory space used by the platform shown in FIG. 1; and

FIG. 7 illustrates a prior art solution.

### DETAILED DESCRIPTION

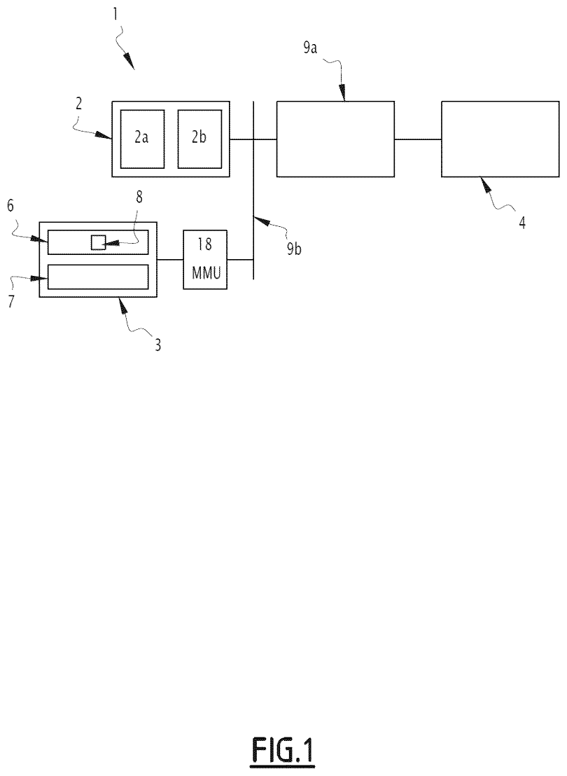

The architecture of a platform 1 for the execution of avionics applications allowing concurrent access to data, without increasing latency and respecting robust partitioning and allowing incrementability, is presented in relation to FIG. 1.

The platform 1 comprises a multi-core processor 2, a memory 3 and shared resources 4. The multi-core processor 2 comprises, e.g., at least two cores denoted by 2a and 2b in FIG. 1. The memory 3 comprises a random-access memory 6 and a non-volatile memory 7. The non-volatile memory 7 is apt to store a plurality of applications which may be executed by the multi-core processor 2 as is explained in greater detail hereafter. The random-access memory 6 comprises a shared memory space 8 which may be a processor cache memory, e.g., of level L2, or a DDR physical memory. The shared resources 4 have in particular, IO peripherals such as AnIO, DsIO, A429, Fbus, Xtalk, known per se. Such shared resources are connected to the multi-core processor 2 via e.g., a communication interface 9a using a data bus 9b. Furthermore, a management unit 18 is associated with the memory 3. The unit 18 is called the Memory Management Unit (MMU) and makes it possible to guarantee correct sharing of the memory 3 while following the read and write permissions for each partition at a given address.

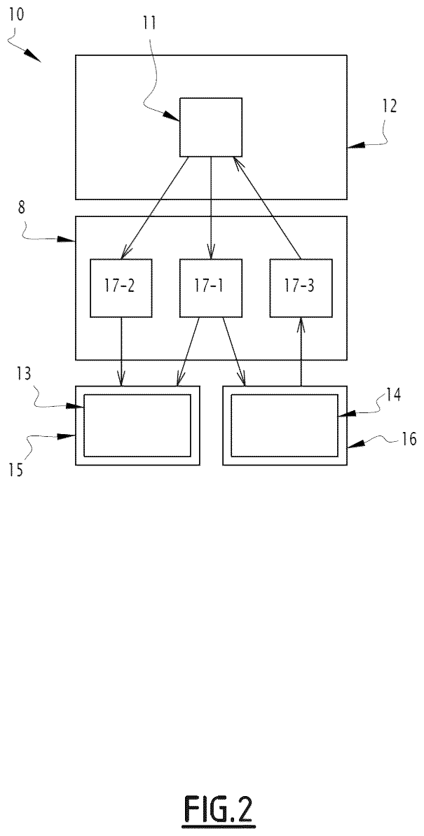

FIG. 2 shows an example of a software architecture 10 implemented on the hardware platform 1 shown in FIG. 1. More particularly, in such example of software architecture, at least one application stored in the non-volatile memory 7 uses an IOTC server 11 for accessing the shared resources 4. The IOTC server is executed within a kernel 12 of the real-time operating system and provides a single point of access to the shared resources 4. The kernel 12 forms a partition and may run on one or a plurality of cores of the multi-core processor 2. In the present example, at least two other applications stored in the non-volatile memory 7 use two avionics applications 13, 14 that run within two avionics partitions 15, 16, respectively.

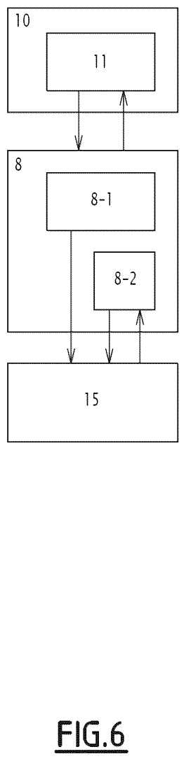

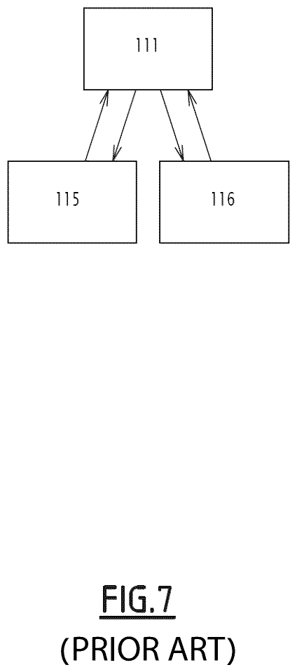

With reference to FIG. 6, the shared memory space 8 comprises a first shared memory zone 8-1 and, for each avionics partition 15, 16, a second shared memory zone 8-2. In FIG. 6, only one second shared zone 8-2 is illustrated in relation to the avionics partition 15. The first shared memory zone 8-1 is read-only accessible to all avionics partitions 15, 16. The second shared memory zone 8-2 is read/write accessible to the corresponding avionics partition 15. The management unit 18 serves in particular, to make the different avionics partitions 15, 16 follow the reading/writing in said different zones.

The IOTC server 11 and the avionics partitions 15, 16 are apt to share data with each other using the shared memory space 8. More particularly, data sharing between the avionics partitions 15, 16 on the one hand and the IOTC server 11 on the other hand is possible only via the shared memory space 8.

To this end, the shared memory space 8 comprises at least three data sharing structures 17-1, 17-2 and 17-3. Each data sharing structure 17-1, 17-2 and 17-3 is dedicated to a particular type of sharing between a data producing partition and one or a plurality of data consuming partitions.

Thereafter, “data producing partition” means that the IOTC server 11 or one of the avionics partitions 15, 16, when the server or the partition produces data intended for one or a plurality of avionics partitions 15, 16 or for the IOTC 11, respectively.

“Data consuming partition” means the IOTC server 11 or one of the avionics partitions 15, 16 when the server or the partition receives data produced by one of the avionics partitions 15, 16 or by the IOTC 11, respectively.

Each data sharing structure 17-1, 17-2 and 17-3 is distributed in the shared memory space 8 between the different shared memory zones 8-1, 8-2 according to the needs of the corresponding avionics partition(s), to modify or not modify, each datum or metadatum, as will be explained in more detail thereafter.

Each avionics partition 15, 16 is implemented using, e.g., a library for accessing the corresponding data sharing structures. The access library embodies the methods of access to the data of said structures.

Each data sharing structure 17-1, 17-2 and 17-3 comprises a plurality of addresses for saving the same data to allow concurrent access to the data through the data producing partition and the or each data consuming partition. The number of savings is chosen according to the type of structure, as will be explained in more detail thereafter.

Furthermore, each data sharing structure 17-1, 17-2 and 17-3 comprises at least one metadatum for determining a data saving address to be used. In other words, by means of the metadata, the producer partition and the or each consumer partition can determine the write/read saving address of the corresponding datum.

### Structure of the First Type

In the example described, the data sharing structure 17-1 is a structure of the first type, also called the Kernel to User Sampling (KUS) data structure, which is dedicated to the broadcast by the IOTC server 11 of a datum with a plurality of partitions either in parallel, or sequentially or both. In other words, for said structure of the first type, the IOTC server 11 acts as a data producing partition and the avionics partitions 15 and 16 act as data consuming partitions.

In general, a structure of the first type KUS is used when the IOTC server 11 needs to broadcast data to a predetermined group of N avionics partitions where N is an integer greater than or equal to 0. Said number may in particular be equal to 0 or 1 for an incremental certification. The structure of the first type allows the IOTC server 11 to write at least two different data (a preceding datum and a following datum) to be transmitted, while allowing the N avionics partitions of the corresponding group to read the preceding datum. In other words, the concurrent access to the datum is possible due to said data structure. In order for data to be written and read in competition, the metadata of the structure of the first type are used by the IOTC server 11 and the avionics partitions to determine the write memory address (the read memory address, respectively) of the current datum. To allow concurrent read and write, N+2 addresses are used in said data structure (N is the number of partitions in the corresponding group), so that at any given time, the IOTC server 11 may write a following datum at an address while the avionics partitions may read a preceding datum at another address. The metadata used thereby serve to determine, for each read or write need, at which address, among the N+2 available, the read or write operation should be performed.

To maintain robust partitioning, the IOTC server 11 manages the metadata. It is the guarantor of the determination of addresses according to the read or write operations to be performed. The IOTC server 11 reserves, progressively as the writes are to be performed, one address among the N+2 addresses available. The presence of an available address is always ensured, due to the number N+2 of usable addresses. When an avionics partition wishes to read a datum, same identifies, within the metadata of the structure, an address available for reading. To prevent a corruption of the metadata, before each write, the IOTC server 11 compares the consistency of the metadata made available by avionics partitions during a preceding write and a current write. When an inconsistency is detected, an alert is raised.

According to a particular example, the metadata associated with the structure of the first type comprises a locking index of each saving address among the N+2 addresses. The index shows if the corresponding address is being read by an avionics partition. The data structure has N+1 locking indices, thus by construction, there is always an address available for the following write.

The structure of the first type 17-1 is distributed in the shared memory space 8 between the first shared memory zone 8-1 (for storing data and metadata) and each second shared memory zone 8-2 (for storing metadata) associated with the corresponding avionics partition 15, 16.

In general, in the shared memory space there are at least as many structures of the first type as there are groups of N avionics partitions sharing data from the IOTC server 11.

### Structure of the Second Type

The data sharing structure 17-2 is a structure of the second type, also called the Kernel to User Queuing (KUQ) data structure, which is dedicated to the transmission, by the IOTC server 11, of data to a single avionics partition. The avionics partition 15 is shown in the example in FIG. 2. In other words, for said structure of the second type, the IOTC server 11 acts as a data producing partition and the avionics partition 15 acts as a data consuming partition.

In general, a structure of the second type KUQ allows the IOTC server 11 to write a following datum, while allowing the corresponding avionics partition to read a preceding datum. In other words, the concurrent access to the datum is possible due to said data structure. To this end, the structure of the second type defines a queue (also called FIFO) of depth P, where the number P is an integer greater than or equal to 1, advantageously greater than or equal to 2. Thereby, such structure defines P consecutive data saving addresses to be transmitted.

In order to allow concurrent writing and reading of data, the metadata of the data structure are used by the IOTC server 11 and the corresponding avionics partition to determine the write memory address (the read memory address, respectively) of the corresponding datum. The metadata used thereby serve to determine, for each read or write need, at which address, among the P available, the read or write operation should be performed.

To maintain robust partitioning, the IOTC server 11 manages the metadata. It is the guarantor of the determination of addresses according to the read or write operations to be performed. To this end, when determining the address to be used to write data, the server makes a copy of the metadata made available by the corresponding avionics partition and compares the metadata made available with the metadata the server kept from the preceding write iteration. The comparison serves to verify that the corresponding avionics partition does not perform an erroneous “read”, in the sense that the partition does not indicate that the datum can be read at a location that is inconsistent with the location of the preceding write iteration.

According to one particular example, the metadata used by the IOTC server 11 comprise two counters: one incremented at each read and the other incremented at each write. The IOTC server 11 duplicates the read counter in the second shared memory zone 8-2 associated with the corresponding avionics partition 15 so that the partition 15 may increment same at each read. When determining the write address, the IOTC server 11 checks the consistency of the duplicate read counter before updating the original read counter.

The structure of the second type 17-2 is distributed in the shared memory space 8 between the first shared memory zone 8-1 (for storing data and metadata) and the second shared memory zone 8-2 (for storing metadata) associated with the corresponding avionics partition 15.

In general, there are at least as many structures of the second type as there are avionics partitions that require individually receiving data from the IOTC server 11.

### Structure of the Third Type

The data sharing structure 17-3 is a structure of the third type, also called the UKQ (User to Kernel Queuing) data structure, which is dedicated to the transmission, by a single avionics partition, to the IOTC server 11. The avionics partition 16 is shown in the example in FIG. 2. In other words, for the structure of the third type, the IOTC server 11 acts as a data consuming partition and the avionics partition 16 acts as a data producing partition.

In general, a structure of the third type UKQ allows the IOTC server 11 to read a following datum, while allowing the corresponding avionics partition 16 to write the following datum to be transmitted. In other words, the concurrent access to the datum is possible due to said data structure. To this end, as in the preceding case, the structure of the third type defines a queue (also called FIFO) of depth P, where the number P is an integer greater than or equal to 1, advantageously greater than or equal to 2. Thereby, such structure defines P consecutive data saving addresses to be transmitted.

In order for the data to be written and read in competition, the metadata of the UKQ structure of the third type are used by the corresponding avionics partition and by the IOTC server 11 to determine the write memory address (the read memory address, respectively) of the corresponding data. The metadata used thereby serve to determine, for each read or write need, at which address, among the P available, the read or write operation should be performed.

To maintain robust partitioning, the IOTC server 11 monitors the metadata. It is the guarantor of the determination of the read addresses to be performed. To this end, when determining the address to be used to read data, the server makes a copy of the metadata made available by the corresponding avionics partition and compares the metadata made available with the metadata the server kept from the preceding write iteration. The comparison verifies that the partition is not performing an erroneous “write”, in the sense that the partition does not indicate that the data can be written to a location that is inconsistent with the preceding read iteration.

According to one particular example, the metadata used by the IOTC server 11 comprise two counters: one incremented at each read and the other incremented at each write. The IOTC server 11 duplicates the write counter in the second shared memory zone associated with the corresponding avionics partition 16 so that the partition 16 can increment same at each write. When determining the read address, the IOTC server 11 checks the consistency of the duplicate write counter before updating the original write counter.

The structure of the third type 17-3 is distributed in the shared memory space 8 between the first shared memory zone 8-1 (for storing metadata) and the second shared memory zone (for storing data and metadata) associated with the corresponding avionics partition 16.

In general, there are at least as many structures of the third type as there are avionics partitions that need to transmit data to the IOTC server 11.

In some embodiments, for a given avionics partition, a plurality of data structures of the same type can be implemented. For example, if an avionics partition wishes to transfer two different types of data to the IOTC server 11, corresponding to two types of IO that the IOTC server 11 as such should transfer to two IO hardware devices, then two different structures of the third type can be used. Similarly, for the IOTC server 11 when same needs to allow partitions to read a plurality of different types of data from several IO hardware devices, a plurality of different structures of the first or the second type can then be used.

The use of the data structures previously presented to share data within the platform 1, is illustrated thereafter. To make the description simpler, the example in FIG. 2 is used to illustrate the methods of managing and accessing data structures 17-1, 17-2, 17-3.

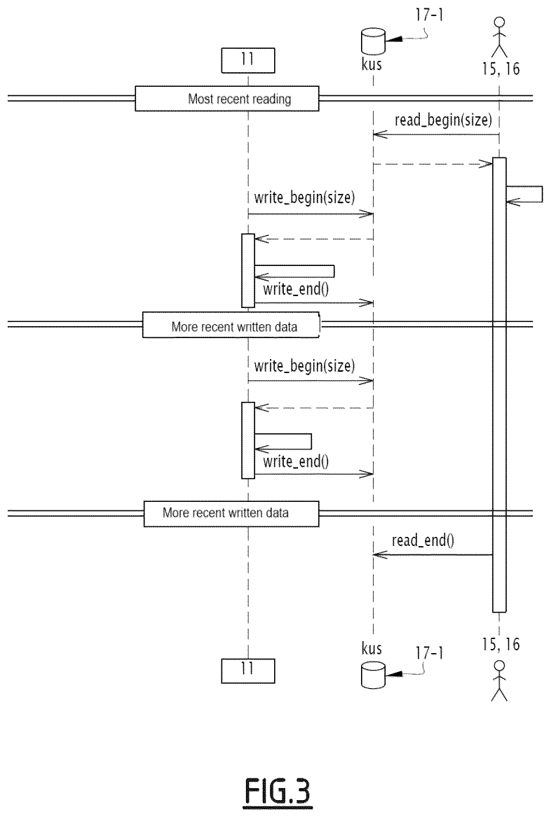

In the first situation, illustrated with reference to FIG. 3, the IOTC server 11 makes available, within the structure of the first type 17-1 (KUS), for a determined number N of partitions, data coming from an IO peripheral. The IO device generates data at a specific generation rate: data generation is not synchronized with data consumption. The IOTC server 11 sequentially retrieves the consecutive data to be transmitted and makes same available to the N partitions 15, 16 that have the utility thereof. In such situation, competition is possible between the IOTC server 11 and the partitions 15, 16. Such mechanism allows the partitions 15, 16 to always be able to read the most recent datum produced by the IOTC server 11 and the IOTC server 11 to always be able to write a following datum. Moreover, such operations should be carried out without the IOTC server 11 being able to be errored by the partitions with regard to the address at which the following datum should be saved.

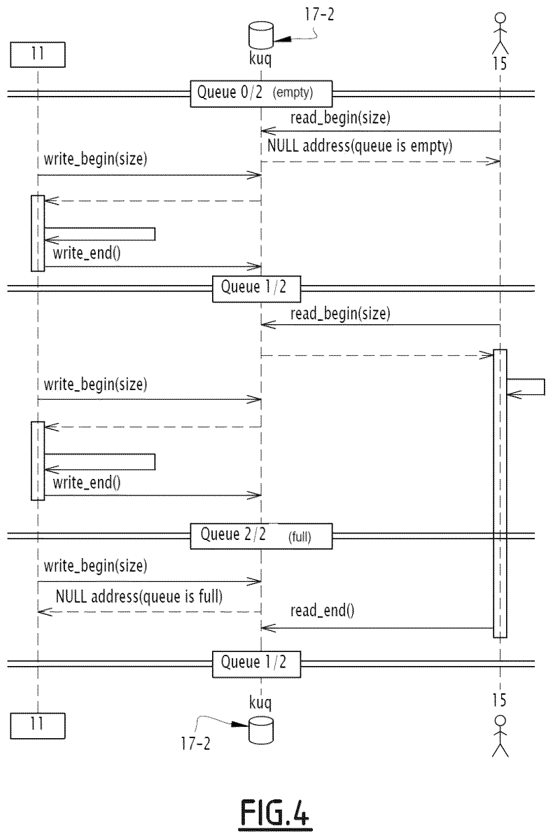

In the second situation, illustrated with reference to FIG. 4, the IOTC server 11 makes a datum available for (only) one partition 15. For example, thereof is a datum coming from an IO peripheral (AnIO, DsIO, A429, Fbus, Xtalk) or a message. The IOTC server 11 makes the datum available at a specific pace: the making available is not synchronized with the data consumption. In such situation, competition is possible between the data producing partition (IOTC server 11) and the data consuming partition (the partition 15). To prevent such situation, when reading the datum at the beginning of the queue by the partition 15, the IOTC server 11 has the option of writing a following datum to the following address of the queue. The following datum will be read by the partition 15 after the end of reading of the preceding datum.

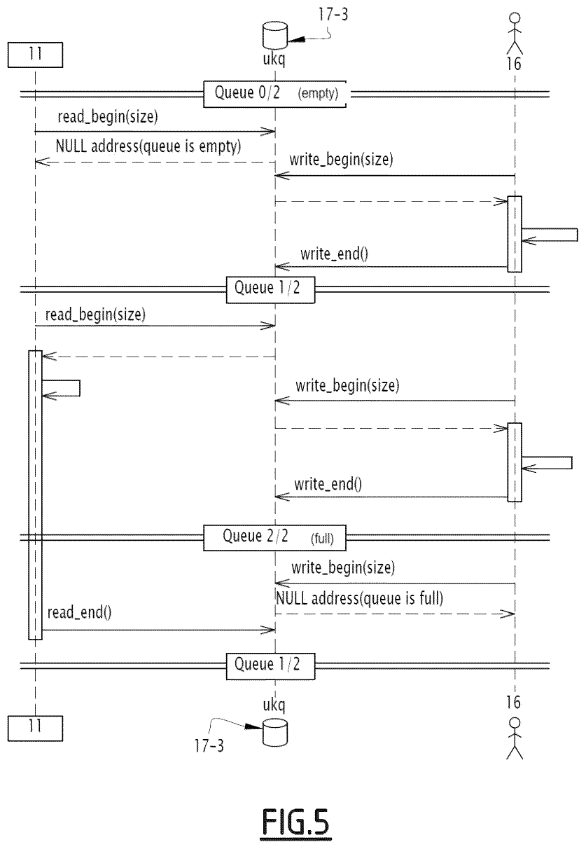

In the third situation, illustrated in relation to FIG. 5, the principles applied are the same as for the second situation. The difference is that the IOTC server 11 acts as a data consuming partition and the avionics 16 partition acts as a data producing partition.

In all situations, regardless of the role assigned to it (producer or consumer), the IOTC server 11 ensures the consistency of the metadata that are present in the corresponding data structures. In this way, the robust partitioning is maintained and the IOTC server 11 can guard against metadata corruption by partitions and maintain the integrity thereof.

1. A platform for executing avionics applications, comprising:
a multi-core processor;
a management unit;
a plurality of shared resources; and
a memory comprising:
a plurality of avionics partitions executing a plurality of avionics applications by said multi-core processor;
an IOTC server for access to shared resources by said avionics partitions; and
a shared memory space, access of which is controlled by said management unit, the shared memory space performing data sharing between a data producing partition and a predetermined group of N data consuming partitions exclusively via a data sharing structure allocated in the shared memory space, the or each data producing/consuming partition corresponding to said IOTC server or to one of said avionics partitions, the data sharing structure comprising at least two saving addresses which are used by the data producing partition to write two different data.

2. The platform according to claim 1, wherein said shared memory space comprises a first shared memory zone and, for each of said avionics partitions, a second shared memory zone, the first shared memory zone being read-only accessible to all of said avionics partitions, and each second shared memory zone being read/write accessible to the corresponding avionics partition, wherein said management unit makes the different avionics partitions follow the reading/writing in the different zones.

3. The platform according to claim 2 wherein the data sharing structure is distributed between the zones according to the need thereof to write/read corresponding data.

4. The platform according to claim 1, wherein the data sharing structure further comprises at least one metadatum for determining a data saving address to be used by the or each data producing/consuming partition.

5. The platform according to claim 1, wherein the data sharing structure has a structure of a first type when N is strictly greater than 1, wherein the data producing partition corresponds to said IOTC server and each data consuming partition corresponds to one of said avionics partitions, and wherein the structure of the first type comprises N+2 saving addresses.

6. The platform according to claim 5, wherein among the N+2 saving addresses of the structure of the first type, two addresses are dedicated to the writing by the data producing partition of a preceding datum and a following datum, and N other addresses are dedicated to the reading by each of the N data consuming partitions of the predetermined group, of the preceding datum.

7. The platform according to claim 5, wherein said shared memory space comprises a structure of the first type for each group of N avionics partitions sharing the data produced by said IOTC server.

8. The platform according to claim 5, wherein the data sharing structure has a structure of a second type when N equals 1, the data producing partition corresponding to said IOTC server and the data consuming partition corresponding to a single avionics partition, wherein the at least two saving addresses form a queue for reading/writing a preceding datum and a following datum.

9. The platform according to claim 5, wherein the data sharing structure has a structure of a third type when N is equal to 1, the producer partition corresponding to a single avionics partition and the consumer partition corresponding to said IOTC server, and wherein the at least two saving addresses form a queue for reading/writing a preceding datum and a following datum.

10. The platform according to claim 5, wherein said shared memory space comprises a plurality of data sharing structures, each data sharing structure corresponding to a structure of the first type, a structure of a second type, or a structure of a third type.

11. The platform according to claim 5, wherein said shared memory space comprises:
a plurality of data sharing structures, each data sharing structure corresponding to a structure of the first type, a structure of a second type or a structure of a third type; and
a structure of the second type and/or a structure of the third type for each of said avionics partitions, wherein the data sharing structure has a structure of the second type when N equals 1, wherein the data producing partition corresponds to said IOTC server, wherein the data consuming partition corresponds to a single one of said avionics partitions, and wherein the at least two saving addresses form a queue for reading/writing a preceding datum and a following datum.

12. A method for executing avionics applications, implemented by the platform according to claim 1, the method comprising writing two different data into two saving addresses of the or each data sharing structure, by the data producing partition.

13. A computer program comprising software instructions which, when executed by a programmable electronic system, implement a method according to claim 12.
